(19) United States
(12) Patent Application Publication
(10) Pub. No.: US 2026/0244872 A1
(43) Pub. Date: Aug. 20, 2026

(54) Systems and Methods for Context-Aware Provisioning of Data

(71) Applicant: Nationstar Mortgage LLC, d/b/a/ Mr. Cooper, Coppell, TX (US)

(72) Inventors: Sridhar Honnavali Sharma, Frisco, TX (US); Malcolm Parish, Dallas, TX (US); Sudhir Hulikunte Sundararam, Round Rock, TX (US)

(73) Assignee: Nationstar Mortgage LLC, d/b/a/ Mr. Cooper, Coppell, TX (US)

(21) Appl. No.: 19/058,899

(22) Filed: Feb. 20, 2025

(51) Int. Cl. G06F 40/35; G06F 16/355

(52) U.S. Cl. CPC G06F 40/35; G06F 16/355

(57) ABSTRACT

In some aspects, the disclosure is directed to methods and systems for context-aware data provisioning. “Paths” or sequences of selected and provisioned content and corresponding sentiment may be identified, and grouped or classified into cohorts. When a new session is initiated, the system may monitor content and corresponding sentiment to identify a corresponding previously-generated cohort, and may then select and provision subsequent content according to the cohort's sequence or path. Thus, while unaware of session context, the system may still select context-relevant (or avoid selecting context-irrelevant) content for provisioning.

### FIELD OF THE DISCLOSURE

This disclosure generally relates to systems and methods for data processing. In particular, this disclosure relates to systems and methods for selection and provisioning of data based on context.

### BACKGROUND OF THE DISCLOSURE

Artificial intelligence systems, such as large language models (LLMs), have achieved some success in generating responses to queries and providing data or content, though difficulties remain. When integrating these systems with other tools, the lack of understanding of context inherent in most implementations of artificial intelligence systems result in inaccuracies or inconsistencies. For example, different response content may be required based on more than just the query, and a system that does not consider an extended sequence interactions may be unable to select the proper content based on context. Such context may not even be readily apparent from a single interaction or series of interactions, but may only be gleaned through comparison of cross-session data.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is an illustration of a series of interactions with content provided by a context-aware content provisioning system, according to some implementations;

FIG. 2 is a block diagram of a context-aware content provisioning system, according to some implementations;

FIG. 3 is a flow chart of a method for generating event summaries by a context aware content provisioning system, according to some implementations;

FIG. 4 is a flow chart of a method for determining intent classifications by a context aware content provisioning system, according to some implementations;

FIG. 5 is a flow chart of a method for classifying sentiment of interactions by a context aware content provisioning system, according to some implementations;

FIG. 6 is a flow chart of a method for processing interactions by a context aware content provisioning system, according to some implementations;

FIG. 7A is an illustration of an example of identifying a user according to an interaction sequence cohort, according to some implementations;

FIG. 7B is another illustration of an example of identifying a user according to an interaction sequence cohort, according to some implementations;

FIG. 8 is a flow chart of a method for context-aware provisioning of data, according to some implementations; and

FIGS. 9A and 9B are block diagrams depicting embodiments of computing devices useful in connection with the methods and systems described herein.

The details of various embodiments of the methods and systems are set forth in the accompanying drawings and the description below.

### DETAILED DESCRIPTION

For purposes of reading the description of the various embodiments below, the following descriptions of the sections of the specification and their respective contents may be helpful:
Section A describes embodiments of systems and methods for context-aware provisioning of data; and
Section B describes a computing environment which may be useful for practicing embodiments described herein.

### A. Systems and Methods for Context-Aware Provisioning of Data

Artificial intelligence (AI) systems, including large language models (LLMs) such as generative pre-trained transformers (GPTs) or other such systems, have achieved some success in generating responses to queries and providing data or content. However, when integrating these systems with other tools, the lack of understanding of context inherent in most implementations of artificial intelligence systems results in inaccuracies or inconsistencies. For example, different response content may be required based on more than just the query, and a system that does not consider an extended sequence of interactions may be unable to select the proper content based on context. Such context may not even be readily apparent from a single interaction or series of interactions, but may only be gleaned through comparison of cross-session data.

Where responses and/or content or data retrieval are performed without context-awareness, the data may be at best redundant and at worst, irrelevant or incorrect. For example, a context-naive or context-agnostic implementation may retrieve a patient's entire medical history or user's transaction history, when only a specific subset is needed, requiring increased processing and memory resources and adding latency. In another example, a context-naive or context-agnostic implementation may retrieve instructions for troubleshooting a broken or impaired device which include steps that have already been performed (e.g. “verify that the device is receiving power”, “verify that the device is connected to a network”, when such statuses have been confirmed). Accordingly, retrieval of these instructions may be unnecessary, wasting time and resources.

A particular difficulty in creating a context-aware content provisioning system is that a computing system likely lacks awareness or understanding of the underlying data: that is, a medical record or a transaction record or a network access log are merely strings or arrays of data that may be human-readable, but lack any particular significance to a processor compared to other data strings. Because the arrays or strings may not be themselves executable, but are data to be retrieved or processed according to other executable instructions, the computing system may lack any subjective understanding of the data context or distinction compared to random data, null data, or unrelated data. Thus, while a human may make subjective determinations in selecting and provisioning data, a computing system may have to instead execute specific, limited mathematical rules in a distinct manner.

In one aspect, the present disclosure is directed to systems and methods for context-aware data provisioning. While a processing system may not have a subjective understanding of context, a reasonable facsimile may be created through recording and classifying “experiential paths” or sequences of selected and provisioned content and corresponding sentiment. These paths may be grouped or classified into cohorts. When a new session is initiated, the system may monitor content and corresponding sentiment to identify a corresponding previously-generated cohort, and may then select and provision subsequent content according to the cohort's sequence or path.

As used herein, data or content may refer to any type and form of data, including retrieved answers from a knowledge base or search engine, documents related to a query or user initiating a query, or other such content. For example, in one implementation of an AI system for supporting customer service, an AI tool may respond to queries and retrieve documents related to a client account, device or system documentation, transaction records, medical records, or any other such data. In another implementation of an AI system for supporting physicians, an AI tool may respond to queries and retrieve documents related to patient health records, pharmaceutical indications, surgical records, diagnostic charts, or any other such data. In still another implementation of an AI system for supporting programmers, an AI tool may respond to queries and retrieve code snippets, libraries, function calls, application programming interface (API) specifications, or other such data. In many implementations, queries may be explicit (e.g. “retrieve data relating to [x]”) while in other implementations, queries may be implicit (e.g. retrieving information relating to a patient or user record responsive to the patient or user being involved in an event or interaction with the AI system). In some implementations, queries may comprise a mix of implicit and explicit queries. Implicit queries may, in some implementations, be referred to as anticipated or proactive queries, and the system may retrieve relevant data or content prior to and/or without receiving an explicit query. In some implementations, this may allow for pre-fetching of data or content, thereby reducing latency.

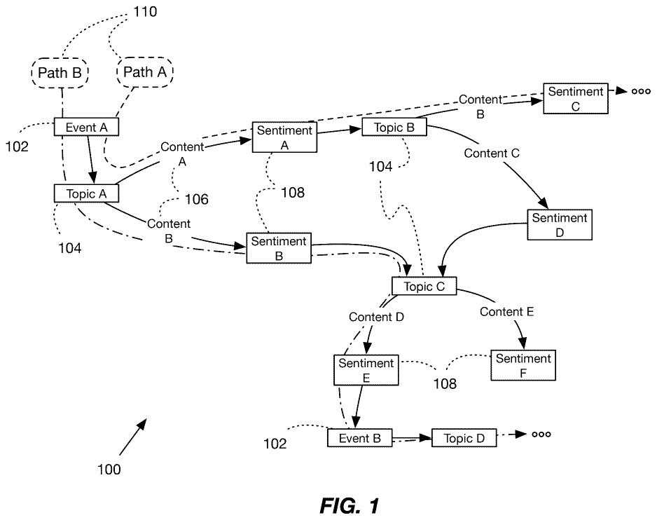

FIG. 1 is an illustration 100 of a series of interactions with content 106 provided by a context-aware content provisioning system, according to some implementations. Starting from a first event 102 (i.e. event A), which may comprise a beginning of an interaction, a user and/or device may follow a sequence of interactions with content 106 and resulting sentiments 108, with the sequence sometimes referred to as a path 110. An event 102 may be an interaction or start of a session (or portion of a session), such as a consultation between a physician and patient, an access by a user device to a server, a customer contact with a service provider, or any other such interaction. Interactions or events 102 may comprise text communications (including non-real time communications such as email or regular mail, as well as real time communications such as text chat), video communications and/or voice communications, computer communications (e.g. exchange of requests and responses via an API, remote procedure calls, representational state transfer (RESTful) requests and responses, etc.), or any other type and form of interactions. Interactions may be asynchronous in some implementations. That is, a second event 102 (e.g. event B) may not necessarily immediately follow a first event 102 (e.g. event A). Some amount of time may occur between events, such as seconds, minutes, days, weeks, or any other amount of time.

An event 102 may correspond to a topic 104, and in some implementations, a system may determine a topic 104 from the event. For example, an event 102 (e.g. event A) may be initiated by a patient consulting a physician about a pain, or an administrator identifying an intrusion alarm on a network device. The system may identify a corresponding topic 104 (e.g. pain, anomalous access, etc.) based on contents of a query, metadata, associated documents, etc. For example, based on detection of a trigger of a packet filter, a system may identify a potential attack as a corresponding topic. In another example, based on a customer request for a balance inquiry, a system may identify an account balance as a corresponding topic. Topics may be identified via keyword identification within the query, metadata, or associated documents, and/or via similar keywords (e.g. semantic clustering). For example, a system may parse an input query or document for keywords and identify semantically related concepts (e.g. via a knowledge graph or keyword clustering). In some implementations, a topic may be referred to as an intent or by similar terms. Thus, in response to an event, an intent may be identified (e.g. diagnosis of a complaint or event, gathering information about an event, etc.) and corresponding content may be selected for presentation.

Once a topic or intent is identified, the system may provide various content items 106 (e.g. content A, content B). As discussed above, content may be any type and form of data, including query responses, documents, transaction values, knowledge base articles, translations, images, video, audio, links to external or internal resources, executable code, or any combination of these or other data. In some implementations, content items 106 may include metadata or other identifiers to identify a corresponding topic or intent.

Responsive to providing a content item 106, the system may measure a sentiment 108. A sentiment 108 may comprise a score or identifier of a positive, negative, or neutral reaction from a user, device, or other recipient of content 106. In some implementations, a system may provide a response to a query from a user and receive a further query or statement or other indicator from the user identifying a positive, negative, or neutral reaction. For example, in some implementations, a system may provide a configuration or settings for a network device or other computing device in response to an identification of an anomalous packet or other alert, and may receive a subsequent measurement of latency, throughput, processor utilization, or any other such metric or metrics or a change in such metrics, with increased performance corresponding to a positive sentiment and decreased performance corresponding to a negative sentiment. In another implementation, a system may provide a question or script for service agent to ask a user and may monitor for a positive or negative response, indicating a correspondingly positive or negative sentiment.

The sentiment score or classification as positive, negative, or neutral may be explicitly provided by a user or client (e.g. selecting a “yes” or “no” or similar indicator, providing a performance measurement or other metric, etc.), and/or may be inferred based on a response or further query (e.g. a first request for content, a first item of content being provided, and a second request for the content with additional parameters implying that the first item of content was less useful or incomplete and thus associated with a negative sentiment).

As shown in FIG. 1, different sequences of events 102, topics or intents 104, content 106, and sentiments 108 may be provided or determined, as shown by paths 110 A and B (in dashed line and dashed-and-dotted line respectively). For example, path A shows event A associated with topic A, provisioning of content A resulting in sentiment A, a subsequent topic B, provisioning of content B resulting in sentiment C, etc. Path B shows event A associated with topic A, provisioning of content B resulting in sentiment B, a subsequent topic C, provisioning of content D resulting in sentiment E, a subsequent event B and topic D, etc. As shown, the same content may be selected or provisioned in response to different sentiments and/or topics (e.g. content B being provided to a client user or device after identification of topic B after being provided with content A resulting in sentiment A as shown in path A; or being provided to a client user or device after identification of topic A as shown in path B). For example, topic A may represent a query for documentation, and content A and B may be irrelevant and relevant documentation respectively, resulting in a negative sentiment A or positive sentiment B. Topic B may be a further request for the documentation, resulting in the system subsequently providing content B and ideally resulting in a positive sentiment (though potentially not as high scoring as if the content were initially provided without the re-request).

As discussed above, the system may be agnostic or naive to the subject matter or specific contents of any content item 106. However, selection or provisioning of more relevant content may be performed as a result of increases in sentiment scores associated with providing the content in response to a particular topic or query. Accordingly, the system may provide improved selection and provisioning through this context awareness, reducing unnecessary waste of processing, memory, or network resources, while remaining agnostic to the specific content itself. Advantageously, in some implementations, the content may even be inaccessible to the system, such as encrypted data that the system cannot decrypt. Proper content selection may be learned for even such inaccessible data through sentiment scoring of intent or topic-content pairs or associations, a function unavailable to provisioning systems lacking implementations of the systems and methods discussed herein.

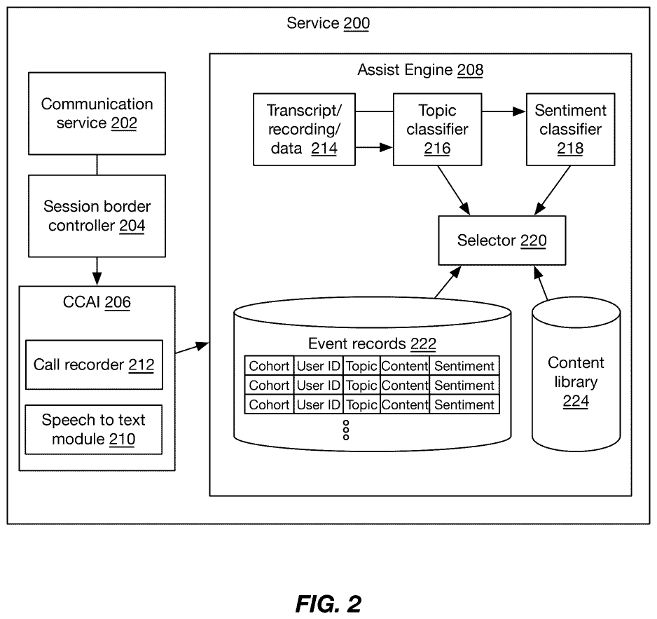

FIG. 2 is a block diagram of a context-aware content provisioning system or service 200, according to some implementations. Service or system 200 may be provided by or comprise one or more computing devices, such as workstations, desktop computers, rackmount computers, laptop computers, tablet computers, or any other type and form of computing device, including virtual computing devices executed by one or more physical computing devices. For example, service or system 200 may comprise a server farm or cloud, appliance cluster, or other set of one or more computing devices. Service or system 200 may be in communication with one or more client devices (not illustrated) operating on behalf of one or more users.

In some implementations, service 200 may comprise a communication service 202. Communication service 202 may comprise an interface for communicating with one or more client devices and/or users. For example, in some implementations, communication service 202 may comprise one or more network interfaces, network devices, firewalls, gateways, switches, or other devices. In other implementations, communication service 202 may comprise a telecommunications provider or service, such as a Session Initiation Protocol (SIP) provider, SIP trunk, SIP codecs, voice-over-internet-protocol (VoIP) provider, VoIP codecs, and/or other such hardware or servers. In some implementations, a communication service 202 may provide an interface between service 200 and external communications networks, such as the Internet, telephony systems, broadband networks, etc. Although shown as part of service 200, in some implementations, communication service 202 may be external, such as one or more third-party service providers and/or servers.

In some implementations, service 200 may comprise a session border controller (SBC) 204. SBC 204 may comprise a device or system configured to manage communication between a communication service 202 and other parts of service 200. SBC 204 may comprise a gateway, firewall, switch, or other such communication device for regulating communication flows. In some implementations, SBC may provide security functionality (e.g. packet filtering, denial of service attack mitigation, etc.), quality of service (QoS) assurance, protocol interworking, session routing, or other such features. Although shown as part of service 200, in some implementations, SBC 204 may be external, such as one or more third-party service providers and/or servers.

In some implementations, service 200 may comprise a contact center artificial intelligence (CCAI) platform 206. A CCAI platform 206 may comprise hardware and/or software for queuing and routing client interactions including voice and data communications. CCAI platform may interface between communication service 202 and/or SBC 204 and other components of service 200. In some implementations, CCAI may also be referred to as a contact center as a service (CCaaS). In some implementations, CCAI 206 may provide advanced telephony or communications functions, including recording calls (e.g. via a call recorder 212) and converting voice data or speech to text (e.g. via a speech to text module 210). CCAI 206 may comprise one or more memory devices or communicate with one or more memory devices (including cloud storage services, network attached storage devices, etc.) for storing call data. In some implementations, CCAI 206 may comprise one or more media servers for transcoding and/or retransmitting received and/or recorded voice data. In some implementations, CCAI 206 may also record multimedia and/or video calls, perform speech to text transcription of video calls, perform translation of voice and/or text between languages, or other such functions.

In some implementations, service 200 may comprise an assist engine 208. Assist engine 208 may comprise a server, service, daemon, routine, or other executable logic. Assist engine 208 may comprise hardware, software, or a combination of hardware and software. Assist engine 208 may comprise one or more computing devices (e.g. a cloud of virtual machines executed by one or more physical computing devices, servers, or other computing devices) for identifying communication topics or intents, selecting and provisioning content, and determining sentiment scores or reactions. In some implementations, assist engine 208 may identify cohort groups among topic/content sequences or paths, and/or may assign new communication sessions (and/or users or client devices) to cohort groups for content selection and provisioning.

In some implementations, assist engine 208 may receive voice and/or video recordings, transcripts, or other data 214 from CCAI 206 (and/or communication service 202, or SBC 204). related to a user or client device session. Such data 214 may include metadata, user or client device information, or other such data, and may be in any format or combination of formats. For example, voice recordings may comprise compressed MP3 data, with metadata and/or transcripts in XML data. This data may be provided as individual files or separately.

In some implementations, assist engine 208 may comprise an intent, purpose, or topic classifier 216, referred to generally as a topic classifier 216. Topic classifier 216 may comprise an application, service, server, daemon, routine, or other executable logic for parsing and identifying one or more topics within a transcript 214 or other communication record (e.g. access log, database request, API call or remote procedure call, etc.). In some implementations, topic classifier 216 may comprise an artificial intelligence or machine learning-based classifier. For example, in some implementations, topic classifier 216 may parse or extract keywords from a transcript, recording, or other data 214 or portion of a transcript, recording, or other data (e.g. to identify sub-topics in a multi-topic conversation or exchange). Topics may be identified via semantic analysis or clustering. In some implementations, keywords may be mapped to a knowledge graph to identify related keywords indicative of a topic. This may help distinguish between keywords that may be related to multiple topics (e.g. “bridge” and networking vs. civil engineering) based on surrounding keywords.

In some implementations, assist engine 208 may comprise a sentiment classifier 218. Sentiment classifier 218 may comprise an application, service, server, daemon, routine, or other executable logic for parsing and identifying a sentiment score or classification from a transcript 214 or other communication record. In some implementations, sentiment classifier 218 may perform natural language processing to analyze transcript or data 214 or other records. In some implementations, sentiment classifier 218 may receive an explicit identifier or score (e.g. a selection of a positive or negative rating) to be used as a sentiment score for a previously provisioned item of content and topic association. In some implementations, sentiment classifier 218 may receive or measure an implicit identifier of a sentiment score, such as one or more performance metrics or change in metrics, or a change in topic indicating that a previous topic or intent was satisfied. For example, in some implementations, a sentiment classifier 218 may measure a processor utilization of a network device before and after providing a configuration file, and identify a based on an increase or decrease in utilization a corresponding positive or negative sentiment. In another implementation, a sentiment classifier 218 may identify a positive comment (e.g. “thanks”) after providing a requested document to a user or agent, and identify a positive comment for the document and topic or intent combination.

In some implementations, an assist engine 208 may comprise a content selector or provisioner 220, referred to generally as a selector 220. Selector 220 may comprise an application, service, server, daemon, routine, or other executable logic for selecting and providing content from a content library 224, including documents, configuration files, knowledge base articles, scripts, transaction records, user or patient records, diagnostic information, test results, billing statements, account statements, or any other type and form of content, including human-readable and/or machine-readable content. Content library 224 may comprise any type and form of data storage, and may comprise one or more internal and/or external memory devices. In some implementations, content library 224 may be external to an assist engine 208 (e.g. cloud storage, network attached storage, storage as a service, storage appliances or clusters of computing devices, etc.).

Selector 220 may select content based on topics and/or cohorts, as discussed above. In some implementations, content initially selected to be provided to a client may not be optimal or may be inaccurately selected. However, by measuring or monitoring sentiment via responses from the client or performance metrics, a score for the content selection may be increased or decreased. Selector 220 may select content from a set of associated content based on the score, such that content with higher scores indicating previous positive sentiment when provided to the client or user or other clients or users may be selected more often. This is similar to an unsupervised learning process, with selection accuracy improving over iterations. However, by further incorporating the sequence of topics/intents, content, and corresponding sentiment scores into paths and grouping by cohort, further content may be provided prior to requests or prior to receiving an indicator of a subsequent topic. Accordingly, over time, the system may become more proactive and accurate at pre-fetching or provisioning desired content prior to any request or indication of interest. As noted above, this reduces latency and may also reduce the number of communications required from client devices, as their needs are met prior to initiating a request.

To aid in content selection, in some implementations, records of content and associated sentiment scores or indicators may be stored in a database 222. In some implementations, these records may further identify a corresponding content and/or intent. Such identifications may include keywords, strings, globally unique identifiers (GUIDs), cluster identifiers, semantic identifiers, or other such indicators. In some implementations, the records may further identify a user identifier or device identifier that was provided with the content after an identification of a corresponding topic or intent, and for which a sentiment score was received or determined. In some implementations, the records may further identify a cohort membership for the user or device identifier and/or topic, content, and sentiment association. In some implementations, records may be indexed or ordered in order to identify a path or sequence, as discussed above. For example, a first record may identify a first device identifier, a first topic, a first content, and a corresponding first sentiment; and a second record may indicate it is a subsequent record to or linked to the first record, and may identify the first device identifier, a second topic, a second content, and a corresponding second sentiment. In some implementations, ordering may be implicit (e.g. a series of consecutive entries in an array or database). In some implementations, ordering may be explicit. For example, a record may be associated with an index, and may include a value identifying a previous record index and/or identifying a subsequent record index for a session or sequence. Event records 222 may be stored in any suitable format, such as an array, a flat file, a relational database, etc.

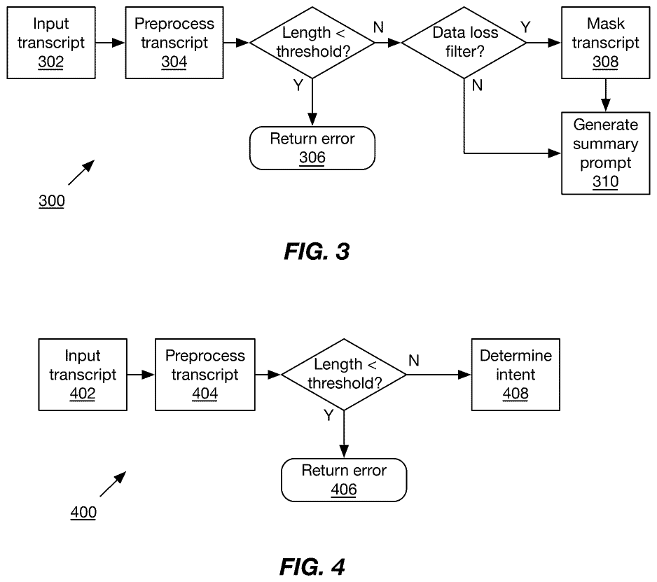

FIG. 3 is a flow chart of a method 300 for generating event summaries by a context aware content provisioning system, according to some implementations. In some implementations, a transcript may be input into or received by the system and/or assist engine at step 302. The transcript may be in any suitable format, such as XML data, alphanumeric or text data, etc. In some implementations, the system may generate the transcript from a recording, such as a voice or video recording. In other implementations, the transcript may be a packet log, communications log, or other log of device interactions or communications. In some implementations, the transcript may include requests, such as API calls, RPC requests, RESTful requests, or other protocol requests. In some implementations, the transcript may comprise natural language. In some implementations, the transcript may comprise a historical record of interactions with a client device or user. For example, rather than just a transcript or log of a most-recent call or communication session, the transcript may comprise a historical transcript or log of previous calls or communication sessions in addition to a present call or session. This may allow for more comprehensive analysis of context or intent.

At step 304, in some implementations, the transcript may be preprocessed by the system and/or assist engine. In various implementations, preprocessing the transcript may comprise generating a summary of the transcript or portions of the transcript. For example, the system and/or assist engine may provide the transcript to a LLM or other natural language processing engine to generate a summary based on semantic analysis of the transcript or portions of the transcript. In some implementations, preprocessing the transcript may comprise dividing the transcript into a plurality of portions for summarization. For example, where the transcript includes multiple topics or intents, they may be referred to as sub-topics in some implementations. Accordingly, in some implementations, the transcript may be divided into separate transcript portions or segments.

In some implementations, the system and/or assist engine may verify that the transcript or portion has a length above a threshold. If not, at step 306, the system and/or assist engine may return an error. In some implementations, the transcript may need to have a minimum length to provide enough context for content selection. For example, a transcript of a communication session including just an initial handshake or synchronization may not provide sufficient context for the system to select or provision content. Similarly, an initial portion of a call transcript with greetings may not include enough text to infer intent. Accordingly, the system and/or assist engine may verify that the length is above a threshold before performing further processing or provisioning of content.

In some implementations, the system and/or assist engine may include a data loss prevention handler. For example, some transcripts may include sensitive information, such as usernames or passwords, personal information, or other data for which anonymization or masking may be useful. If data loss prevention is enabled for the session, in some implementations at step 308, the system and/or assist engine may apply masking or filtering to the transcript or portion(s) of the transcript to mask sensitive data. This may include applying a regex or other filters to remove or replace sensitive data (e.g. with a null string, random string, predetermined string, encrypted string, etc.).

At step 310, in some implementations, the system and/or assist engine may generate a prompt or request for content selection using the generated summary. The request may be in any suitable format and may include any additional information (e.g. a prior prompt, an identification of intent or topic, a summary of the transcript, or any other such information) that may be useful for selecting or provisioning content.

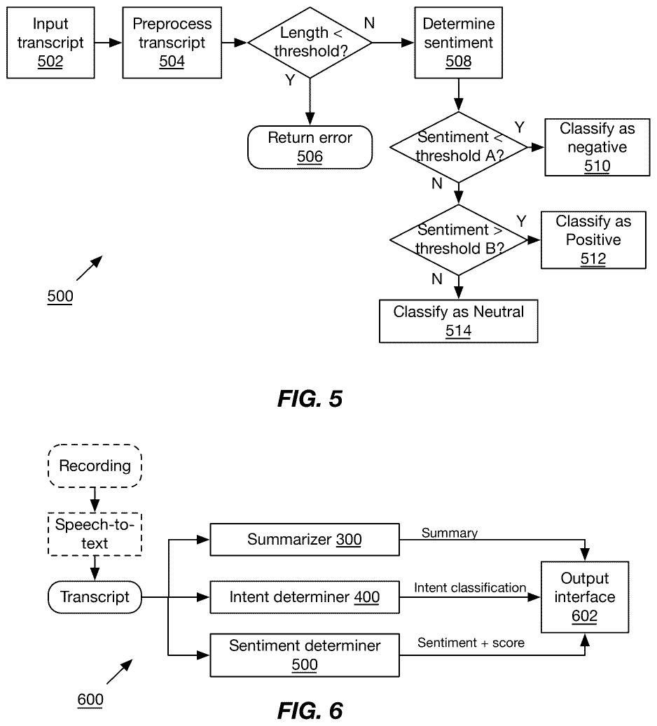

FIG. 4 is a flow chart of a method 400 for determining intent classifications by a context aware content provisioning system, according to some implementations. In some implementations, a transcript may be input into or received by the system and/or assist engine at step 402. The transcript may be in any suitable format, such as XML data, alphanumeric or text data, etc. In some implementations, the system may generate the transcript from a recording, such as a voice or video recording. In other implementations, the transcript may be a packet log, communications log, or other log of device interactions or communications. In some implementations, the transcript may include requests, such as API calls, RPC requests, RESTful requests, or other protocol requests. In some implementations, the transcript may comprise natural language. In some implementations, the transcript may comprise a historical record of interactions with a client device or user. For example, rather than just a transcript or log of a most-recent call or communication session, the transcript may comprise a historical transcript or log of previous calls or communication sessions in addition to a present call or session. This may allow for more comprehensive analysis of context or intent.

At step 404, in some implementations, the transcript may be preprocessed by the system and/or assist engine. Preprocessing the transcript may comprise extracting a section or portion of the transcript for processing, as discussed above.

In some implementations, the system and/or assist engine may verify that the transcript or portion has a length above a threshold. If not, at step 406, the system and/or assist engine may return an error. In some implementations, the transcript may need to have a minimum length to provide enough context for content selection. For example, a transcript of a communication session including just an initial handshake or synchronization may not provide sufficient context for the system to select or provision content. Similarly, an initial portion of a call transcript with greetings may not include enough text to infer intent. Accordingly, the system and/or assist engine may verify that the length is above a threshold before performing further processing or provisioning of content.

At step 410, in some implementations, the system and/or assist engine may determine an intent or topic for the transcript or a portion of the transcript. In some implementations, determining the intent may comprise generating a prompt for an LLM or other natural language processing engine to extract keywords and/or perform semantic analysis to determine a topic or intent from the transcript or a portion of the transcript. The system and/or assist engine may execute the LLM or processing engine or generate the prompt and provide the prompt and transcript or transcript portion to another computing device executing the LLM or processing engine. The request may be in any suitable format and may include any additional information (e.g. a prior prompt, a summary of the transcript, or any other such information) that may be useful for selecting or provisioning content.

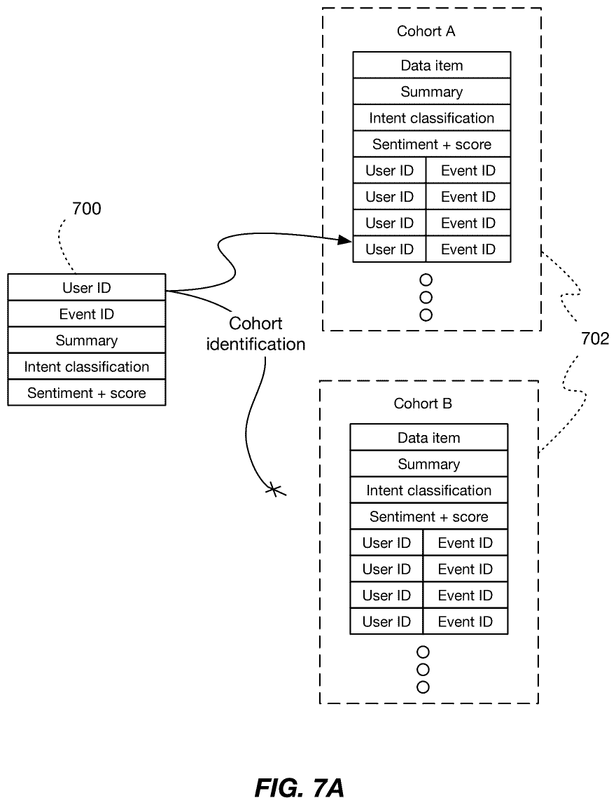

FIG. 5 is a flow chart of a method 500 for classifying sentiment of interactions by a context aware content provisioning system, according to some implementations. In some implementations, a transcript may be input into or received by the system and/or assist engine at step 502. The transcript may be in any suitable format, such as XML data, alphanumeric or text data, etc. In some implementations, the system may generate the transcript from a recording, such as a voice or video recording. In other implementations, the transcript may be a packet log, communications log, or other log of device interactions or communications. In some implementations, the transcript may include requests, such as API calls, RPC requests, RESTful requests, or other protocol requests. In some implementations, the transcript may comprise natural language. In some implementations, the transcript may comprise a historical record of interactions with a client device or user. For example, rather than just a transcript or log of a most-recent call or communication session, the transcript may comprise a historical transcript or log of previous calls or communication sessions in addition to a present call or session. In some implementations, the transcript may comprise performance measurements or metrics. In some implementations, the system and/or assist engine may generate a request for performance measurements or metrics, or a change in performance measurements or metrics since a prior request or measurement or relative to prior to providing content to a client device or user.

At step 504, in some implementations, the transcript may be preprocessed by the system and/or assist engine. Preprocessing the transcript may comprise extracting a section or portion of the transcript for processing, as discussed above. In some implementations, preprocessing the transcript may comprise determining a delta or change in a performance metric, such as a difference between a latency measurement made after providing a configuration setting and before providing the configuration setting. Accordingly, in such implementations, preprocessing the transcript may comprise extracting a measurement value from the transcript, retrieving a previous measurement value from memory, and determining a difference between the measurement values. In some implementations, preprocessing the transcript may comprise identifying a previously provided content item for association with a sentiment determined from the transcript.

In some implementations, the system and/or assist engine may verify that the transcript or portion has a length above a threshold. If not, at step 506, the system and/or assist engine may return an error. In some implementations, the transcript may need to have a minimum length to provide enough context for content selection. For example, a transcript of a communication session including just an initial handshake or synchronization may not provide sufficient context for the system to select or provision content. Similarly, an initial portion of a call transcript with greetings may not include enough text to infer sentiment. Accordingly, the system and/or assist engine may verify that the length is above a threshold before performing further processing or determining sentiment.

In some implementations, at step 508, the system and/or assist engine may determine a sentiment from the transcript or portion of the transcript. In some implementations, the system and/or assist engine may determine a sentiment after providing content or data, and the sentiment may be associated with providing the content or data responsive to an identification of a corresponding topic or intent. As discussed above, sentiment may be determined implicitly (e.g. from further queries or portions of the transcript, from performance measurements or metrics, etc.) or may be determined explicitly (e.g. from a selection of a positive or negative identifier by a user or device, etc.). Sentiment may be represented by discrete values or classifications (e.g. positive, negative, neutral; or 1, 0, −1), or may be represented by a sentiment score within a given range (e.g. −10 to 10, 0 to 100, or any other suitable values). In some implementations, sentiment may be classified as negative at step 510, positive at step 512, or neutral at step 514 relative to lower and upper thresholds (e.g. thresholds A and B). For example, at step 508, in some implementations, the system and/or assist engine may determine a sentiment score between 0 and 10, and then compare the score to predetermined thresholds (e.g. 3 and 7) to determine whether the score is negative (e.g. less than 3), positive (e.g., greater than 7) or neutral, (e.g. equal to or between 3 and 7). Any other such values may be utilized, depending on implementation.

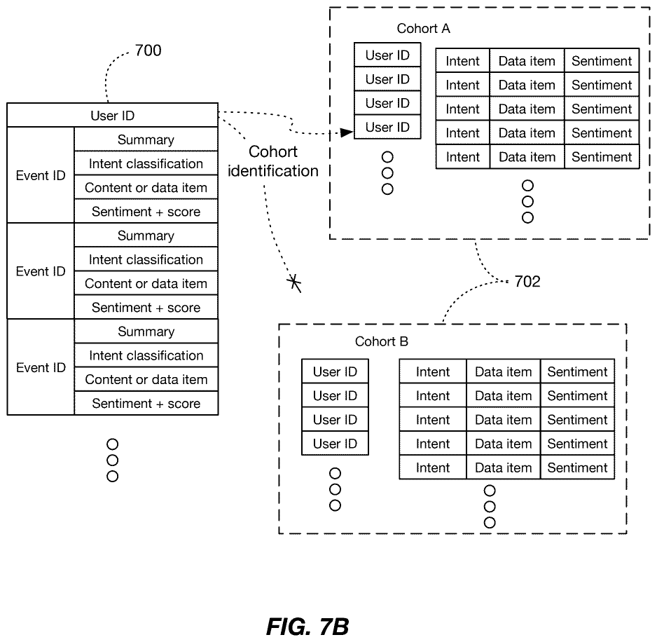

FIG. 6 is a flow chart of a method 600 for processing interactions by a context aware content provisioning system, according to some implementations. As discussed above, the system and/or assist engine may receive a transcript or log (or, in some implementations, may receive a recording and perform a speech-to-text transcription). In some implementations, the transcript or portion(s) of the transcript may be provided to a summarizer executing an implementation of method 300, an intent or topic determiner executing an implementation of a method 400, and a sentiment determiner executing an implementation of a method 500, as discussed above. Although shown in parallel, in some implementations, these methods may be performed in serial or asynchronously. As discussed above, each of these functions may be provided by a trained machine learning model, such as an LLM, semantic analyzer, natural language processing engine, etc. The generated summary, intent or topic classification, and sentiment classification (and optionally score or metrics) may be provided to an output interface 602. In various implementations, the output interface 602 may comprise a display for a user or agent, a network interface to communicate the generated data to a remote computing device, be an API interface to a content selector, etc.

As discussed above, in some implementations, paths or sequences of content provisioning may be grouped into cohorts. A sequence of {topic, content, sentiment} triples may be common to a plurality of users and/or devices, such as [{topic A, content A, positive sentiment}, {topic B, content B, negative sentiment}, {topic C, content C, positive sentiment}, etc.]. Such users and/or devices may be classified as belonging to a cohort with a corresponding sequence of triples. When a new session is initiated for a user or device and initial portions of the corresponding transcript comprise triples matching the start of a cohort sequence, the user or device may be identified as likely belonging to the cohort, and subsequent content may be selected and provisioned, prior to a request or identification of topic. For example, given a cohort with a topic/content/sentiment sequence as shown above, upon identifying a pending session for a client device or user with a sequence of [{topic A, content A, positive sentiment}, {topic B, content B, negative sentiment}], the system may identify the client device or user as likely belonging to the cohort, and may pre-fetch and provision content C. Such sequences may be quite long and extend over multiple sessions, and thus the cohort classification may grow more accurate over time. Additionally, this may allow for extensive pre-fetching and provisioning of content (e.g. with a cohort sequence of 20 content interactions, if a user or device may be classified as belonging to the cohort after 5 interactions, 15 additional content items may be pre-fetched and provisioned without requiring further requests or communications, drastically reducing communications and processing resource requirements).

In some implementations, content provided to a cohort and associated with a negative sentiment (e.g. content B in the example above) may be not provisioned. That is, given the example cohort sequence above, if a user or client device is identified as likely belonging to the cohort, the system may skip provisioning content B and instead pre-fetch and provision content C. For example, if the content is a set of filter configurations for a network device, and after being provided with content B, performance metrics decline for members of the cohort, then the system may avoid providing content B to new devices identified as likely belonging to the cohort. Similarly, if the content is a set of diagnostic tests for a patient, a physician whose patient is identified as likely belonging to the cohort may not be provided with diagnostic test B as the results are less likely to be relevant or useful. Similarly, if the content is related to services offered to a customer likely belonging to the cohort, an agent may not be provided with a script to offer a service that is declined or poorly received by other cohort customers. Accordingly, through identifying cohorts via topic/content/sentiment sequences, the system may avoid providing less relevant or useful content, and may pre-fetch and provision more useful and relevant content, thereby increasing processing and communications efficiency. As noted above, the resource savings can be significant, eliminating or avoiding both requests for relevant content by pre-fetching and provisioning the content in advance, and eliminating resource costs of providing irrelevant content.

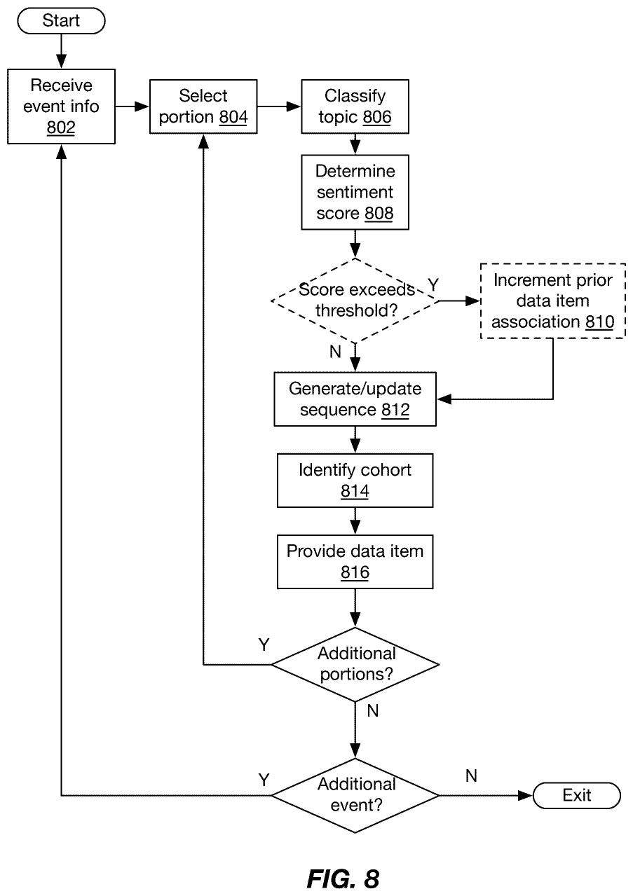

FIG. 7A is an illustration of an example of identifying a user or client device according to an interaction sequence cohort, according to some implementations. In some implementations, a user or device record 700 may identify a user or device identifier (e.g. a username, GUID, MAC address, IP address, device name, or other such identifier). In some implementations, the record may also identify an event or session or portion of a session. For example, as discussed above, interactions with a user or client may extend over long periods and at intermittent intervals (e.g. a first session on day one, a second session on day ten, a third session on day twelve, etc. ; or a first communication at time A, a second communication at time B, etc.). Sequences may be mapped over multiple such communication sessions, and accordingly, an event identifier or index may provide for identification of ordering of topic/content/sentiment associations. The record may comprise a transcript summary (e.g. an identification of a request, a communication type, or any other such information), an identification of a topic or intent, and a sentiment classification or score value.

In some implementations, the record may be compared to records for one or more cohort groups 702, which may similarly identify transcript summaries, intent classifications, and sentiment classifications or scores. In some implementations, cohort records may also identify content or data items provided to members of the cohort and associated with the intent and sentiment classifications. In some implementations, cohort records may also comprise user or device identifiers and event identifiers that have been classified as part of the cohort. As shown, based on a match between the summary, intent classification, sentiment score and, in some implementations, a data item provided to the client device or user, the user identifier may be associated with (and potentially added to the cohort record for) one cohort rather than the other.

FIG. 7B is another illustration of an example of identifying a user or device according to an interaction sequence cohort, according to some implementations. Similar to the example of FIG. 7A, a user or device record 700 may be associated with a plurality of event identifiers corresponding to sub-topics or portions of a transcript and corresponding summaries or intents, data or content items, and associated sentiment scores or values, with the event identifiers providing an ordered sequence (which may be implicitly ordered or explicitly ordered, as discussed above). Each cohort 702 may be similarly associated with a sequence of intents or topics, data or content items, and associated sentiment scores or values, as well as user or device identifiers that have been classified as belonging to the cohort. As shown, the intent/content/sentiment triples for cohorts may be longer than those identified in a pending session transcript; once classified as corresponding to a cohort, the additional content may be pre-fetched and provisioned to the user or device corresponding to the pending session, as discussed above.

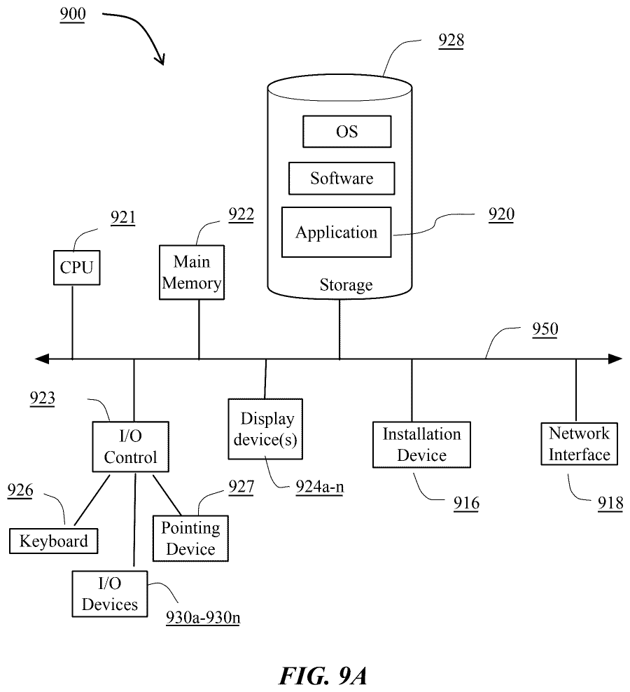

FIG. 8 is a flow chart of a method 800 for context-aware provisioning of data, according to some implementations. In some implementations, a session may be initiated and at step 802, a system and/or assist engine may receive event information, such as a voice or video recording, a transcript, a communication log, an API request, a RESTful request, an RPC, or any other type and form of textual or non-textual communication for which a context may be determined and content provisioned. The event information may comprise a portion of a transcript in some implementations. The transcript may comprise a transcript of a verbal communication or a transcript of a written communication, or may comprise a transcript of a communication session in some implementations. The event information may be received in any suitable format, such as a media file, a text file, an XML file, a binary file, a data array, a flat file, or any other type and form of data. The event information may comprise a communication transcript associated with a user and/or client device, and may comprise one or more portions corresponding to one or more topics or intents.

In some implementations, the system and/or assist engine may generate a communication transcript from audio data using a speech-to-text engine. Such a speech-to-text engine may be provided or executed by the system or assist engine, or may be provided by another computing device, and the system and/or assist engine may provide the audio data and/or a portion of the audio data for transcription and receive the transcription. In some implementations, such as where the audio data is recorded or captured during a pending session, transcription may occur “live” or to previous portions of the audio while additional audio is being recorded. Accordingly, in such implementations, the system and/or assist engine may receive a first portion of audio data and generate a transcription, and then receive additional audio data, generate an additional transcription portion, and append the additional transcription portion corresponding to the additional audio data to a communication transcript.

In some implementations, the communication transcript may be partitioned into a plurality of sub-topics or portions. In some implementations, the system and/or assist engine may partition the transcript based on an identification of different entities involved in the communication. In some implementations, the system and/or assist engine may partition the communication transcript into a plurality of portions based on a classification of a first portion of the communication transcript being associated with a different topic than a subsequent portion of the communication transcript.

At step 804, in some implementations, the system and/or assist engine may select a portion of the communication transcript or event log. The portion may be a first portion, a portion corresponding to a topic or intent, a sliding window from the transcript, or any other such portion (e.g. 100 words, 250 words, 500 words, one paragraph, speech or text identified as corresponding to one person of a conversation, a communication or request from one device to another device, etc.).

At step 806, in some implementations, the system and/or assist engine may classify the portion of the communication transcript as associated with a topic or intent. As discussed above, in some implementations, this may be performed via a trained machine learning model or neural network or classifier performing semantic analysis. In some implementations, keywords may be grouped via a semantic knowledge graph into topics. In some implementations, a classifier may classify vectors corresponding to tokens in a portion of the transcript into topic classifications in an n-dimensional space. The portion may be identified by a topic identifier, topic name, intent name or identifier, or by similar identifiers from a plurality of predetermined topics or intents.

At step 808, in some implementations, the system and/or assist engine may determine a sentiment score based on the communication transcript or portion of the transcript. In some implementations, the sentiment may be determined based on a content of the transcript portion, or based on an explicit identifier provided by a user or device. In some implementations, a first portion of the transcript may correspond to an initial request, prior to any content being provided by the system and/or assist engine. In some such implementations, step 808 may be skipped. In other such implementations, a default or neutral sentiment score may be utilized. In still other such implementations, a sentiment may be determined but not associated with a provided content item.

In some implementations, such as where content or data has been previously provided to the user and/or device (e.g. during a prior session, during the session but corresponding to a previous portion of the transcript, during a prior iteration of steps 804-816, etc.), the system and/or assist engine may determine whether the sentiment score or value exceeds a threshold (e.g. a positive threshold). If so, at step 810, the system and/or assist engine may increase a score for an association between the content or data and a cohort or interaction sequence or path. This threshold may be a different threshold than a threshold used for classifying a sentiment as positive or negative. For example, in some implementations, a sentiment score of 6 may be identified as positive. The system may also use a higher threshold, such as 7, to determine whether an association with the content should be increased. This may allow for finer tuning or higher accuracy of content provisioning based on a cohort or path, and reduce false positives or provisioning of barely relevant content.

In some implementations, at step 812, the system and/or assist engine may generate or update an event record. In some implementations, the event record may identify a sequence of topics or intents. In some implementations, the event record may identify corresponding sentiment scores. In some implementations, the event record may identify content selected or provisioned based on the topic or intent or for which was provided to a cohort associated with the sequence of topics or intents. Updating the record may comprise appending additional identifiers of a topic classification, sentiment score, and or content to an existing record. Records may include implicit ordering (e.g. an ordered series of tuples or triples) or may include explicit ordering (e.g. index values or event or transcript portion identifiers).

In some implementations, at step 814, the system and/or assist engine may identify a cohort corresponding to the sequence of topics or intents and content, or may verify that the sequence still corresponds to a previously identified cohort. In some implementations, the identification may be responsive to a direct match (e.g. a sequence of topics and content identical to a sequence or consecutive portion of a sequence for a cohort), or responsive to a similar or fuzzy match (e.g. a sequence of topics and content that are mostly identical such as 70%, 80%, 90% or any other similar percentage to a sequence or consecutive portion of a sequence for a cohort). In some implementations, the similarity may be determined via a distance between a vector of tuples or triples for the sequence and a vector of tuples or triples for a sequence or consecutive portion of a sequence for the cohort, with the distance being compared to a threshold to determine a match or near match.

At step 816, in some implementations, the service and/or assist engine may select and provide a data item or content to the user and/or device. The data item or content may be selected based on an identification of a subsequent topic or intent and corresponding data item or content in the sequence or sequence portion associated with the identified cohort. In some implementations, a sequence associated with the identified cohort may include multiple content items or branching paths still associated with the cohort (e.g. indicating that one of several content items may be provided in response to an identification of a topic or intent). In some such implementations, a content item or data from the several content items may be selected randomly In some other implementations, a content item or data from the several content items may be selected proportional to an association score associated with each content (e.g. each content item may have an individually-associated score that may be incremented at step 810 based on a positive sentiment for that content item, and the system may randomly select between the content items at a rate proportional to their scores). In some other implementations, a content item or data from the several content items may be selected in a round-robin fashion or other similar algorithm, to ensure that each content item is utilized. Providing the data item or content may comprise transmitting the data item or content to a computing device, displaying the data item or content via a display of a computing device, generating a physical version of the data item or content (e.g. printing the content), displaying the data item or content to an agent in communication with the user or device, etc.

In some implementations, steps 804-816 may be repeated for additional portions of the communication transcript or event data, including additional data received during processing and provisioning (e.g. during a continuing or pending session). Steps 802-816 may be repeated for additional events associated with a user or device, including events after long intervals.

Accordingly, implementations of the systems and methods discussed herein provide context-aware data provisioning. “Paths” or sequences of selected and provisioned content and corresponding sentiment may be identified, and grouped or classified into cohorts. When a new session is initiated, the system may monitor content and corresponding sentiment to identify a corresponding previously-generated cohort, and may then select and provision subsequent content according to the cohort's sequence or path. Thus, while unaware of session context, the system may still select context-relevant (or avoid selecting context-irrelevant) content for provisioning.

In a first aspect, the present disclosure is directed to a method for context-aware provisioning of data. The method includes receiving, by a computing system, a communication transcript associated with a user identifier. The method also includes, for each of a plurality of portions of the communication transcript: classifying, by the computing system via a first trained neural network model, the portion of the communication transcript as associated with a first topic of a plurality of predetermined topics; and determining, by the computing system via a second trained neural network model, a sentiment score associated with the portion of the communication transcript. The method includes generating, by the computing system, a sequence of topic classifications and corresponding sentiment scores for the portions of the communication transcript. The method also includes providing, by the computing system, an item of data associated with the generated sequence from a plurality of items of data.

In some implementations, the method includes receiving a second communication transcript subsequent to providing the item of data; determining a sentiment score associated with the second communication transcript; and incrementing a score for the association of the item of data and the generated sequence responsive to the determined sentiment score exceeding a threshold. In a further implementation, the method includes selecting the item of data to be provided based on the score for the association of the item of data and the generated sequence exceeding a score for the association of a second item of data and the generated sequence.

In some implementations, the method includes classifying, by the computing system, the user identifier as associated with a cohort of user identifiers based on at least an interaction history associated with the user identifier and corresponding interaction histories associated with the cohort. In a further implementation, the classification is further based on a similarity of the generated sequence of topic classifications and corresponding sentiment scores to a sequence of topic classifications and corresponding sentiment scores associated with the cohort. In another further implementation, the method includes selecting the item of data associated with the generated sequence from a subset of items of data associated with the classified cohort.

In some implementations, the item of data comprises a subset of data associated with the user identifier. In some implementations, the method includes receiving, by the computing system, audio data and generating the communication transcript from the audio data using a speech-to-text engine. In a further implementation, the method includes receiving additional audio data and appending an additional portion corresponding to the additional audio data to the communication transcript.

In some implementations, the method includes partitioning the communication transcript into the plurality of portions based on an identification of different entities involved in the communication. In some implementations, the method includes partitioning the communication transcript into the plurality of portions based on a classification of a first portion of the communication transcript being associated with a different topic than a subsequent portion of the communication transcript. In a further implementation, the method includes grouping a plurality of sub-portions of the communication transcript into a portion responsive to each sub-portion being classified as associated with the same topic. In some implementations, the communication transcript comprises a transcript of a verbal communication or a transcript of a written communication.

In another aspect, the present disclosure is directed to a system for context-aware provisioning of data. The system includes a computing system comprising one or more processing devices, and one or more memory devices storing a communication transcript associated with a user identifier. The one or more processing devices are configured to, for each of a plurality of portions of the communication transcript: classify, via a first trained neural network model, the portion of the communication transcript as associated with a first topic of a plurality of predetermined topics; and determine, via a second trained neural network model, a sentiment score associated with the portion of the communication transcript. The one or more processing devices are also configured to generate a sequence of topic classifications and corresponding sentiment scores for the portions of the communication transcript. The one or more processing devices are also configured to provide an item of data associated with the generated sequence from a plurality of items of data.

In some implementations, the one or more processing devices are further configured to: receive a second communication transcript subsequent to providing the item of data; determine a sentiment score associated with the second communication transcript; and increment a score for the association of the item of data and the generated sequence responsive to the determined sentiment score exceeding a threshold. In a further implementation, the one or more processing devices are further configured to select the item of data to be provided based on the score for the association of the item of data and the generated sequence exceeding a score for the association of a second item of data and the generated sequence. In another further implementation, the one or more processing devices are further configured to classify the user identifier as associated with a cohort of user identifiers based on at least an interaction history associated with the user identifier and corresponding interaction histories associated with the cohort. In another further implementation, the classification is further based on a similarity of the generated sequence of topic classifications and corresponding sentiment scores to a sequence of topic classifications and corresponding sentiment scores associated with the cohort. In another further implementation, the one or more processing devices are configured to select the item of data associated with the generated sequence from a subset of items of data associated with the classified cohort.

In some implementations, the item of data comprises a subset of data associated with the user identifier. In some implementations, the one or more processing devices are further configured to receive audio data and generate the communication transcript from the audio data using a speech-to-text engine. In a further implementation, the one or more processing devices are further configured to receive additional audio data and append an additional portion corresponding to the additional audio data to the communication transcript.

In some implementations, the one or more processing devices are further configured to partition the communication transcript into the plurality of portions based on an identification of different entities involved in the communication. In some implementations, the one or more processing devices are further configured to partition the communication transcript into the plurality of portions based on a classification of a first portion of the communication transcript being associated with a different topic than a subsequent portion of the communication transcript. In a further implementation, the one or more processing devices are further configured to group a plurality of sub-portions of the communication transcript into a portion responsive to each sub-portion being classified as associated with the same topic. In some implementations, the communication transcript comprises a transcript of a verbal communication or a transcript of a written communication.

### B. Computing Environment

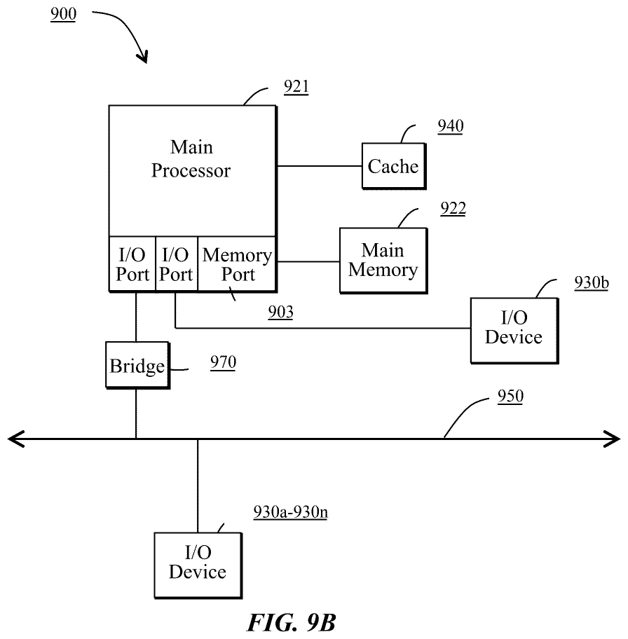

Having discussed specific embodiments of the present solution, it may be helpful to describe aspects of the operating environment as well as associated system components (e.g., hardware elements) in connection with the methods and systems described herein. The systems discussed herein may be deployed as and/or executed on any type and form of computing device, such as a computer, network device, appliance, including virtual computing devices or a virtualized environment (e.g. one or more virtual machines executed by one or more physical computing devices) capable of communicating on any type and form of network and performing the operations described herein. FIGS. 9A and 9B depict block diagrams of a computing device 900 useful for practicing an embodiment of the methods and systems discussed herein. As shown in FIGS. 9A and 9B, each computing device 900 includes a central processing unit 921, and a main memory unit 922. In some implementations, such devices may also include hypervisors and virtualized CPUs for supporting multiple concurrent instances of software components or workloads. As shown in FIG. 9A, a computing device 900 may include a storage device 928, an installation device 916, a network interface 918, an I/O controller 923, display devices 924a-924n, a keyboard 926 and a pointing device 927, such as a mouse. The storage device 928 may comprise any type and form of storage device, including network or virtualized storage devices, and may allow read and/or write access to data including, without limitation, an operating system, software, or other executable logic. As shown in FIG. 9B, Additionally, each computing device 900 may also include additional optional elements, such as a memory port 903, a bridge 970, one or more input/output devices 930a-930n (generally referred to using reference numeral 930), and a cache memory 940 in communication with the central processing unit 921.

The central processing unit 921 is any logic circuitry that responds to and processes instructions fetched from the main memory unit 922. In many embodiments, the central processing unit 921 is provided by a microprocessor unit, such as: those manufactured by Intel Corporation of Mountain View, California; those manufactured by International Business Machines of White Plains, New York; or those manufactured by Advanced Micro Devices of Sunnyvale, California. In virtualized or cloud environments, processors may also include virtualization extensions (e.g., Intel VT-x, AMD-V) to support hypervisors and virtual machines. The computing device 900 may be based on any of these processors, or any other processor capable of operating as described herein.

Main memory unit 922 may be one or more memory chips capable of storing data and allowing any storage location to be directly accessed by the microprocessor 921, such as any type or variant of Static random access memory (SRAM), Dynamic random access memory (DRAM), Ferroelectric RAM (FRAM), NAND Flash, NOR Flash and Solid State Drives (SSD). The main memory 922 may be based on any of the above described memory chips, or any other available memory chips capable of operating as described herein. In addition, memory may include volatile and non-volatile components managed by modern memory hierarchies optimized for cloud workloads. In the embodiment shown in FIG. 9A, the processor 921 communicates with main memory 922 via a system bus 950 (described in more detail below). FIG. 9B depicts an embodiment of a computing device 900 in which the processor communicates directly with main memory 922 via a memory port 903. For example, in FIG. 9B the main memory 922 may be DRDRAM.

In some implementations, computing systems may also support cloud-based architectures, enabling distributed memory management across geographically diverse data centers via networked communications.

FIG. 9B depicts an embodiment in which the main processor 921 communicates directly with cache memory 940 via a secondary bus, sometimes referred to as a backside bus. In other embodiments, the main processor 921 communicates with cache memory 940 using the system bus 950. Cache memory 940 typically has a faster response time than main memory 922 and is provided by, for example, SRAM, BSRAM, or EDRAM. Some systems may integrate processor cache with cloud-optimized memory hierarchies for enhanced performance in virtualized environments. In the embodiment shown in FIG. 9B, the processor 921 communicates with various I/O devices 930 via a local system bus 950. Various buses may be used to connect the central processing unit 921 to any of the I/O devices 930, for example, a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 924, the processor 921 may use an Advanced Graphics Port (AGP) to communicate with the display 924. Some embodiments may utilize PCIe Gen4 or Gen5 buses for higher bandwidth connections and GPU support for artificial intelligence workloads.

FIG. 9B also depicts an embodiment in which local buses and direct communication are mixed: the processor 921 communicates with I/O device 930a using a local interconnect bus while communicating with I/O device 930b directly. In some embodiments involving cloud-enabled architectures, such communication may also be facilitated via advanced interconnect technologies such as NVLink or CXL (Compute Express Link) to optimize data sharing between CPUs and GPUs.

A wide variety of I/O devices 930a-930n may be present in the computing device 900. Input devices include keyboards, mice, trackpads, trackballs, microphones, dials, touch pads, touch screens, and drawing tablets. Output devices include video displays, speakers, inkjet printers, laser printers, projectors, and dye-sublimation printers. The I/O devices may be controlled by an I/O controller 923 as shown in FIG. 9A. The I/O controller may control one or more I/O devices such as a keyboard 926 and a pointing device 927, e.g., a mouse or optical pen. Furthermore, an I/O device may also provide storage and/or an installation medium 916 for the computing device 900. In still other embodiments, the computing device 900 may provide USB connections (not shown) to receive handheld USB storage devices such as the USB Flash Drive line of devices manufactured by Twintech Industry, Inc. of Los Alamitos, California. Some devices may also support Thunderbolt and USB-C connections for faster data transfer and compatibility with external GPUs, storage devices, and displays.

Referring again to FIG. 9A, the computing device 900 may support any suitable installation device 916, such as a disk drive, a CD-ROM drive, a CD-R/RW drive, a DVD-ROM drive, a flash memory drive, tape drives of various formats, USB devices, hard drives, a network interface, or any other device suitable for installing software and programs. In cloud environments, installation devices may also include virtualized disk images or containers, enabling the rapid deployment of services and applications. The computing device 900 may further include a storage device, such as one or more hard disk drives or redundant arrays of independent disks, for storing an operating system and other related software, and for storing application software programs such as any program or software 920 for implementing (e.g., configured and/or designed for) the systems and methods described herein. Optionally, any of the installation devices 916 could also be used as the storage device. Additionally, the operating system and the software can be run from a bootable medium. In some cloud-based architectures, such software and operating systems may be deployed dynamically through Infrastructure as a Service (IaaS) platforms, with persistent storage provided by services such as Amazon S3 or Google Cloud Storage.

Furthermore, the computing device 900 may include a network interface 918 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, IEEE 802.11ac, IEEE 802.11ad, CDMA, GSM, WiMax, and direct asynchronous connections). In some implementations, connections may include support for 5G, LTE, and/or high-speed fiber-optic networks, and/or advanced security protocols such as IPsec or TLS 1.3. In one embodiment, the computing device 900 communicates with other computing devices 900′ via any type and/or form of gateway or tunneling protocol such as Secure Socket Layer (SSL) or Transport Layer Security (TLS). The network interface 918 may include a built-in network adapter, network interface card, PCMCIA network card, card bus network adapter, wireless network adapter, USB network adapter, modem, or any other device suitable for interfacing the computing device 900 to any type of network capable of communication and performing the operations described herein.

In some implementations, systems may also include support for virtual private networks (VPNs), cloud-based software-defined networking (SDN), and edge computing frameworks to facilitate secure, scalable communication.

In some embodiments, the computing device 900 may include or be connected to one or more display devices 924a-924n. As such, any of the I/O devices 930a-930n and/or the I/O controller 923 may include any type and/or form of suitable hardware, software, or combination of hardware and software to support, enable or provide for the connection and use of the display device(s) 924a-924n by the computing device 900. For example, the computing device 900 may include any type and/or form of video adapter, video card, driver, and/or library to interface, communicate, connect or otherwise use the display device(s) 924a-924n. In one embodiment, a video adapter may include multiple connectors to interface to the display device(s) 924a-924n. In other embodiments, the computing device 900 may include multiple video adapters, with each video adapter connected to the display device(s) 924a-924n. In some embodiments, any portion of the operating system of the computing device 900 may be configured for using multiple displays 924a-924n. Some implementations may also support high-resolution displays, including 4K or 8K monitors, and/or virtual reality (VR) or augmented reality (AR) headsets for immersive experiences. Furthermore, advanced GPUs, such as those provided by NVIDIA or AMD, may support AI-enhanced rendering and real-time ray tracing. One ordinarily skilled in the art will recognize and appreciate the various ways and embodiments that a computing device 900 may be configured to have one or more display devices 924a-924n.

In further embodiments, an I/O device 930 may be a bridge between the system bus 950 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a FibreChannel bus, a Serial Attached Small Computer System Interface bus, a USB connection, or an HDMI bus. Some systems may also incorporate Thunderbolt 4, USB4, and/or DisplayPort technologies, providing high-bandwidth connectivity for peripherals such as external GPUs, NVMe storage devices, and advanced docking stations.

A computing device 900 of the sort depicted in FIGS. 9A and 9B may operate under the control of an operating system, which controls scheduling of tasks and access to system resources. The computing device 900 can be running any operating system such as any of the versions of the MICROSOFT WINDOWS operating systems, the different releases of the Unix and Linux operating systems, any version of the MAC OS for Macintosh computers, any embedded operating system, any real-time operating system, any open-source operating system, any proprietary operating system, any operating systems for mobile computing devices, or any other operating system capable of running on the computing device and performing the operations described herein. Operating systems include, but are not limited to: Android, produced by Google Inc. ; WINDOWS 7 and 8, produced by Microsoft Corporation of Redmond, Washington; MAC OS, produced by Apple Computer of Cupertino, California; WebOS, produced by Research In Motion (RIM); OS/2, produced by International Business Machines of Armonk, New York; and Linux, a freely-available operating system distributed by Caldera Corp. of Salt Lake City, Utah, or any type and/or form of a Unix operating system, among others. In cloud computing environments, operating systems may also include containerized operating environments, such as Kubernetes or Docker, enabling distributed, scalable deployments of microservices.

The computer system 900 can be any workstation, telephone, desktop computer, laptop or notebook computer, server, handheld computer, mobile telephone or other portable telecommunications device, media playing device, a gaming system, mobile computing device, or any other type and/or form of computing, telecommunications, or media device that is capable of communication. Some computing systems include cloud-based virtual machines, serverless architectures, and/or edge devices designed for IoT applications. The computer system 900 has sufficient processor power and memory capacity to perform the operations described herein.

In some embodiments, the computing device 900 may have different processors, operating systems, and input devices consistent with the device. For example, in one embodiment, the computing device 900 is a smartphone, mobile device, tablet, or personal digital assistant. In still other embodiments, the computing device 900 is an Android-based mobile device, an iPhone smartphone manufactured by Apple Computer of Cupertino, California, or a Blackberry or WebOS-based handheld device or smartphone, such as the devices manufactured by Research In Motion Limited. In some embodiments, the computing device may be a tablet computing device such as the Apple iPad, Surface devices by Microsoft, or advanced wearable devices such as smartwatches and AR glasses, which operate in conjunction with cloud-based services. Moreover, the computing device 900 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

Although the disclosure may reference one or more “users,” such “users” may refer to user-associated devices or stations (STAs), for example, consistent with the terms “user” and “multi-user” typically used in the context of a multi-user multiple-input and multiple-output (MU-MIMO) environment. In some embodiments, “users” may also include virtualized clients, software agents, or autonomous systems interfacing through cloud-hosted platforms or distributed networks.

Although examples of communications systems described above may include devices and APs operating according to an 802.11 standard, it should be understood that embodiments of the systems and methods described can operate according to other standards and use wireless communications devices other than devices configured as devices and APs. For example, multiple-unit communication interfaces associated with cellular networks, satellite communications, vehicle communication networks, and other non-802.11 wireless networks can utilize the systems and methods described herein to achieve improved overall capacity and/or link quality without departing from the scope of the systems and methods described herein. Some embodiments of networks may also incorporate advanced wireless communication technologies such as 5G NR, millimeter-wave (mmWave), or satellite-based Internet systems such as Starlink, enabling high-bandwidth and low-latency communications across diverse geographic locations.

It should be noted that certain passages of this disclosure may reference terms such as “first” and “second” in connection with devices, modes of operation, transmit chains, antennas, etc., for purposes of identifying or differentiating one from another or from others. These terms are not intended to merely relate entities (e.g., a first device and a second device) temporally or according to a sequence, although in some cases, these entities may include such a relationship. Nor do these terms limit the number of possible entities (e.g., devices) that may operate within a system or environment.

It should be understood that the systems described above may provide multiple ones of any or each of those components, and these components may be provided on either a standalone machine or, in some embodiments, on multiple machines in a distributed system. In cloud architectures, these components may be distributed across virtual machines, containers, or serverless functions within one or more data centers, with orchestration handled by platforms such as Kubernetes, OpenShift, or AWS Lambda. In addition, the systems and methods described above may be provided as one or more computer-readable programs or executable instructions embodied on or in one or more articles of manufacture.

The article of manufacture may be a floppy disk, a hard disk, a CD-ROM, a flash memory card, a PROM, a RAM, a ROM, or a magnetic tape. In general, the computer-readable programs may be implemented in any programming language or framework, including LISP, PERL, C, C++, C#, PROLOG, Python, Go, Rust, JavaScript (e.g., Node.js), or Java. Additionally, software may be developed using frameworks such as TensorFlow or PyTorch for AI workloads, or React and Angular for front-end applications. The software programs or executable instructions may be stored on or in one or more articles of manufacture as object code. Cloud-native applications may also utilize containerized environments, distributed ledgers, or serverless architectures, allowing code to execute dynamically based on predefined triggers and scaling conditions.

In embodiments leveraging software as a service (SaaS), the systems may operate entirely in cloud-hosted environments, enabling users to interact through browser-based interfaces or lightweight client applications, and functionality may be delivered over a network such as the Internet without requiring installation on local devices.

While the foregoing written description of the methods and systems enables one of ordinary skill to make and use what is considered presently to be the best mode thereof, those of ordinary skill will understand and appreciate the existence of variations, combinations, and equivalents of the specific embodiment, method, and examples herein. The present methods and systems should therefore not be limited by the above described embodiments, methods, and examples, but by all embodiments and methods within the scope and spirit of the disclosure.

We claim:

1. A method for context-aware provisioning of data, comprising:
receiving, by a computing system, a communication transcript associated with a user identifier;
for each of a plurality of portions of the communication transcript:
classifying, by the computing system via a first trained neural network model, the portion of the communication transcript as associated with a first topic of a plurality of predetermined topics, and
determining, by the computing system via a second trained neural network model, a sentiment score associated with the portion of the communication transcript;
generating, by the computing system, a sequence of topic classifications and corresponding sentiment scores for the portions of the communication transcript; and
providing, by the computing system, an item of data associated with the generated sequence from a plurality of items of data.

2. The method of claim 1, further comprising:
receiving a second communication transcript subsequent to providing the item of data;
determining a sentiment score associated with the second communication transcript; and
incrementing a score for the association of the item of data and the generated sequence responsive to the determined sentiment score exceeding a threshold.

3. The method of claim 2, further comprising selecting the item of data to be provided based on the score for the association of the item of data and the generated sequence exceeding a score for the association of a second item of data and the generated sequence.

4. The method of claim 1, further comprising classifying, by the computing system, the user identifier as associated with a cohort of user identifiers based on at least an interaction history associated with the user identifier and corresponding interaction histories associated with the cohort.

5. The method of claim 4, wherein the classification is further based on a similarity of the generated sequence of topic classifications and corresponding sentiment scores to a sequence of topic classifications and corresponding sentiment scores associated with the cohort.

6. The method of claim 4, further comprising selecting the item of data associated with the generated sequence from a subset of items of data associated with the classified cohort.

7. The method of claim 1, wherein the item of data comprises a subset of data associated with the user identifier.

8. The method of claim 1, further comprising receiving, by the computing system, audio data and generating the communication transcript from the audio data using a speech-to-text engine.

9. The method of claim 8, further comprising receiving additional audio data and appending an additional portion corresponding to the additional audio data to the communication transcript.

10. The method of claim 1, further comprising partitioning the communication transcript into the plurality of portions based on an identification of different entities involved in the communication.

11. The method of claim 1, further comprising partitioning the communication transcript into the plurality of portions based on a classification of a first portion of the communication transcript being associated with a different topic than a subsequent portion of the communication transcript.

12. The method of claim 11, further comprising grouping a plurality of sub-portions of the communication transcript into a portion responsive to each sub-portion being classified as associated with the same topic.

13. The method of claim 1, wherein the communication transcript comprises a transcript of a verbal communication or a transcript of a written communication.

14. A system for context-aware provisioning of data, comprising:
a computing system comprising one or more processing devices, and one or more memory devices storing a communication transcript associated with a user identifier;
wherein the one or more processing devices are configured to:
for each of a plurality of portions of the communication transcript:
classify, via a first trained neural network model, the portion of the communication transcript as associated with a first topic of a plurality of predetermined topics; and
determine, via a second trained neural network model, a sentiment score associated with the portion of the communication transcript,
generate a sequence of topic classifications and corresponding sentiment scores for the portions of the communication transcript, and
provide an item of data associated with the generated sequence from a plurality of items of data.

15. The system of claim 14, wherein the one or more processing devices are further configured to:
receive a second communication transcript subsequent to providing the item of data;
determine a sentiment score associated with the second communication transcript; and
increment a score for the association of the item of data and the generated sequence responsive to the determined sentiment score exceeding a threshold.

16. The system of claim 15, wherein the one or more processing devices are further configured to select the item of data to be provided based on the score for the association of the item of data and the generated sequence exceeding a score for the association of a second item of data and the generated sequence.

17. The system of claim 14, wherein the one or more processing devices are further configured to classify the user identifier as associated with a cohort of user identifiers based on at least an interaction history associated with the user identifier and corresponding interaction histories associated with the cohort.

18. The system of claim 17, wherein the classification is further based on a similarity of the generated sequence of topic classifications and corresponding sentiment scores to a sequence of topic classifications and corresponding sentiment scores associated with the cohort.

19. The system of claim 14, wherein the one or more processing devices are further configured to receive audio data and generate the communication transcript from the audio data using a speech-to-text engine.

20. The system of claim 19, wherein the one or more processing devices are further configured to receive additional audio data and append an additional portion corresponding to the additional audio data to the communication transcript.
